(19) United States
(12) Patent Application Publication
(10) Pub. No.: US 2026/0321959 A1
(43) Pub. Date: Oct. 15, 2026

(54) APPARATUS, METHOD, AND RADAR SYSTEM

(71) Applicant: Nokia Solutions and Networks Oy, Espoo (FI)

(72) Inventors: Neda KHIABANI, Murray Hill, NJ (US); Michael HOLYOAK, Murray Hill, NJ (US)

(21) Appl. No.: 19/544,370

(22) Filed: Feb. 19, 2026

(30) Foreign Application Priority Data
Feb. 20, 2025 (FI) 20255155

(51) Int. Cl. H01Q 1/12; G01S 7/03; H01Q 1/50; H01Q 13/20

(52) U.S. Cl. CPC H01Q 1/1271; G01S 7/03; H01Q 1/50; H01Q 13/20

(57) ABSTRACT

An apparatus comprises a glass substrate, a conductive radiator plane formed on a first surface of the substrate, a conductive ground plane formed on a second surface of the substrate, the second surface being a surface arranged to oppose the first surface of the substrate, the conductive radiator plane further comprising a first longitudinal slot and a second longitudinal slot, the second longitudinal slot parallel to the first longitudinal slot, the first slot having a first set of dimensions and the second slot having a second set of dimensions, the second set of dimensions being different to the first set of dimensions, a plurality of conductive grounding members arranged to be galvanically coupled between the conductive radiator plane and the ground plane for forming a waveguide, and a feed configured to convey radio frequency signals between the conductive radiator plane and radio frequency circuitry.

### TECHNICAL FIELD

The present disclosure relates, in general, to an apparatus, method and radar system. Aspects relate, in general, to antennas.

### BACKGROUND

Dual-longitudinal Substrate Integrated Waveguide (SIW) antennas comprise a substrate integrated waveguide with two longitudinal slots. The dual-slot configuration serves several functions such as providing impedance matching over a broad frequency range and suppressing the open-stop band.

The SIW technology, on which this antenna is based, comprises multiple rows of conducting cylinders embedded in a substrate, such as a dielectric, that connect two parallel conductive plates, which can be formed on opposing surfaces of the substrate for example. This enables implementation of classical rectangular waveguide components in a planar form, making it compatible with printed circuitry, active devices, and other antenna elements.

### SUMMARY

An objective of the present disclosure is to provide an SIW-fed slot antenna providing wide bandwidth while maintaining simplicity, cost-efficiency, and ease of integration into active circuits.

The foregoing and other objectives are achieved by the features of the independent claims.

Further implementation forms are apparent from the dependent claims, the description and the Figures.

A first aspect of the present disclosure provides an apparatus comprising a glass substrate, a conductive radiator plane formed on a first surface of the substrate, a conductive ground plane formed on a second surface of the substrate, the second surface being a surface arranged to oppose the first surface of the substrate, the conductive radiator plane further comprising a first longitudinal slot and a second longitudinal slot, the second longitudinal slot parallel to the first longitudinal slot, the first slot having a first set of dimensions and the second slot having a second set of dimensions, the second set of dimensions being different to the first set of dimensions, a plurality of conductive grounding members arranged to be galvanically coupled between the conductive radiator plane and the ground plane for forming a waveguide, and a feed configured to convey radio frequency signals between the conductive radiator plane and radio frequency circuitry.

In an implementation of the first aspect, the plurality of conductive grounding members can comprise through-glass vias, TGVs, extending through the glass substrate and connecting the conductive radiator plane to the conductive ground plane.

The first set of dimensions and the second set of dimensions can be selected for the first and second longitudinal slots to provide at least a 20% fractional bandwidth for the apparatus.

The first set of dimensions and the second set of dimensions can be selected for the first and second longitudinal slots to provide a wide instantaneous bandwidth spanning from 270 GHz to 330 GHz.

In an example, the feed can extend into a probe feed cavity configured to excite the waveguide with a transverse electric, TE10, mode. The radio frequency circuitry can be a Radio-Frequency Integrated Circuit, RFIC, through flip-chip bonding, configured to electrically connect with the feed. The glass substrate can be selected to minimize dielectric loss at sub-THz frequencies.

A short-circuited via wall can be provided at one end of the waveguide. The feed can comprise a probe coupled to an anti-pad through the glass substrate. The first and second slots can be non-conductive apertures formed in the conductive radiator plane.

A second aspect of the present disclosure provides an antenna array comprising a plurality of the apparatus according to the first aspect, wherein the first and second slots are mirrored around an axis of symmetry of the array.

In an implementation of the second aspect, the mirrored arrangement of first and second slots can be configured to enhance beam pattern flatness for high-resolution multiple input multiple output, MIMO, radar applications.

A third aspect of the present disclosure provides a method comprising, providing a glass substrate, forming a conductive radiator layer on a first surface of the glass substrate, the conductive radiator layer comprising a pair of parallel longitudinal slots, wherein a first slot of the pair of parallel longitudinal slots comprises a first set of dimensions and the second slot of the pair of parallel longitudinal slots comprises a second set of dimensions, the second set of dimensions being different to the first set of dimensions, forming a conductive ground plane layer on a second surface of the glass substrate, the second surface being a surface arranged to oppose the first surface of the glass substrate, and creating a plurality of through-glass vias, TGVs, connecting the conductive radiator layer and the conductive ground plane layer.

In an implementation of the third aspect, the method can further comprise forming a feed configured to convey radio frequency signals between the top metal layer and radio frequency circuitry. The method can further comprise optimizing dimensions and spacing of the pair of parallel longitudinal slots to achieve a wide instantaneous bandwidth spanning from 270 GHz to 330 GHz, and/or at least a 20% fractional bandwidth. The method can further comprise optimizing parameters of the probe feed cavity to minimize insertion loss from a flip-chip interconnection to the antenna element.

A fourth aspect of the present disclosure provides a MIMO radar system comprising an antenna array configured to transmit radio frequency signals comprising a plurality of apparatus according to the first aspect, or at least one antenna array according to the second aspect, and an antenna array configured to receive radio frequency signals comprising a plurality of apparatus according to the first aspect or at least one antenna array according to the second aspect.

In an implementation of the fourth aspect, each of the plurality of apparatus according to the first aspect in at least one of the transmit and receive array antennas can be dual-longitudinal substrate integrated waveguide, SIW, slot antennas arranged in a mirrored configuration around an axis of symmetry to achieve uniform distribution of radiation energy over a wide angle.

A fifth aspect of the present disclosure provides a method of operating a MIMO radar system, comprising transmitting orthogonal signals using a transmit array antenna comprising dual-longitudinal SIW slot antennas according to first aspect or at least one antenna array according to the second aspect, receiving reflected signals using a receive array antenna comprising dual-longitudinal SIW slot antennas according to the first aspect or at least one antenna array according to the second aspect, and processing the received signals to enhance angular resolution of the radar system.

The dual-longitudinal SIW slot antennas in the transmit and receive array antennas can be arranged in a mirrored configuration around an axis of symmetry to achieve uniform distribution of radiation energy over a wide angle.

A sixth aspect of the present disclosure provides user equipment, comprising an antenna array configured to transmit radio frequency signals comprising a plurality of apparatus according to the first aspect or at least one antenna array according to the second aspect, and an antenna array configured to convey radio frequency signals comprising a plurality of apparatus according to the first aspect or at least one antenna array according to the second aspect.

In an implementation of the sixth aspect, the user equipment can comprise at least one processor, and at least one memory, wherein the at least on memory can store instructions, executable by the processor, to cause the user equipment to convey orthogonal signals using the antenna array, and/or receive signals using the antenna array.

In an example, the user equipment can further comprise instructions, executable by the processor, to cause the user equipment to process received signals to enhance angular resolution for the user equipment.

A seventh aspect of the present disclosure provide a node for a mobile communication network, the node comprising a MIMO radar system according to a fourth aspect.

These and other aspects of the invention will be apparent from the embodiment(s) described below.

### BRIEF DESCRIPTION OF THE DRAWINGS

In order that the present disclosure may be more readily understood, embodiments will now be described, by way of example, with reference to the accompanying drawings, in which:

FIG. 1 is a schematic representation of an apparatus, such as an antenna element, according to an example;

FIG. 2 is a schematic representation of an apparatus according to an example;

FIG. 3 is a schematic representation of an apparatus according to an example;

FIG. 4 is a graph of the scattering parameter (S-parameter) for an apparatus, according to an example;

FIG. 5 is a schematic representation of a flip chip interconnection and probe fed cavity antenna element according to an example;

FIG. 6 is a schematic representation of a multiple-input and multiple-output, MIMO, radar system according to an example; and

FIG. 7 is a schematic representation of an apparatus according to an example.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

The phrases “in one implementation,” or “in some implementations,” may each refer to one or more of the same or different implementations. The term “coupled” is defined as connected whether directly or indirectly through intervening components, electromagnetically (EM) coupled, or capacitively/inductively coupled, for example, and is not necessarily limited to physical, or galvanic, connections. The expression “at least one of A, B and C” or “at least one of the following: A, B and C” means “only A, or only B, or only C, or any combination of A, B and C.”

For the purposes of explanation and non-limitation, specific details such as functional entities, techniques, protocols, and standards are set forth for providing an understanding of the present disclosure. In other examples, detailed disclosure of well-known methods, technologies, systems, and architectures are omitted so as not to obscure the present disclosure with unnecessary details.

Acronyms which may be used herein include:
6G: sixth Generation
BW: Bandwidth
SIW: Substrate Integrated Waveguide
THz: Terahertz
GCPW: Grounded Coplanar Waveguide
PCB: Printed Circuit Board
mmWave: Millimeter Wave
RFIC: Radio-Frequency Integrated Circuit
AiP: Antenna-in-Package
MIMO: Multiple Input Multiple Output
TGV: Through Glass Via
EBG: Electromagnetic BandGap

Sub-terahertz (sub-THz) refers to a part of the electromagnetic spectrum that lies between the millimetre wave (mmWave) and terahertz frequencies. Specifically, it typically ranges from approximately 100 GHz to 300 GHz (approximately 1 mm to 0.1 mm), and is a promising candidate for enabling extremely high-rate, low-latency data services in beyond-5G and 6G wireless networks for example.

Substrate Integrated Waveguide (SIW) antennas offer several benefits for sub-THz applications, making them highly suitable for high-frequency communication systems such as those mentioned above. For example, the combination of high gain, broadband capabilities, low loss, compact design, and cost-effective fabrication makes SIW antennas an excellent choice for sub-THz applications. These benefits address the challenges of operating at such high frequencies, including signal attenuation and integration into modern systems.

The primary challenge in developing sub-THz antennas lies in achieving a wide instantaneous bandwidth while maintaining a low-loss, simple design that can be easily integrated with radio frequency integrated circuits (RFICs). For instance, common longitudinal slot antennas comprising slots that are displaced from the centreline of the SIW and with elements which are separated by a one-half guided wavelength longitudinally which are fabricated on a single-layer dielectric exhibit narrow bandwidth, limiting the achievable resolution in radar systems. To enhance bandwidth, other configurations utilise SIW-fed cavity-backed slot antennas, where transverse slots are placed on the top of the SIW. While these structures can achieve wide bandwidth, they require multilayer printed circuit boards (PCBs) or additional structures (e.g., electromagnetic band Gap (EBG) structures), which increase design complexity and manufacturing costs.

According to an example, there is provided a dual-longitudinal SIW slot antenna on a single-layer glass substrate, which is capable of covering a wide bandwidth (20% or greater fractional bandwidth). The use of an appropriately sized glass substrate at sub-THz frequencies makes it possible to implement antennas with enhanced performance while minimizing dielectric loss, which is a crucial factor for sub-THz systems where low-loss components are essential to overcome the significant losses encountered at high frequencies.

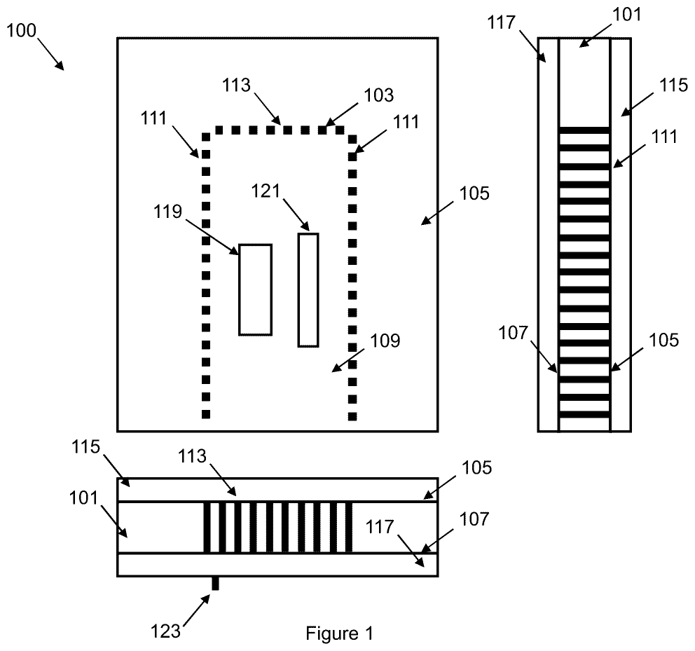

FIG. 1 is a schematic representation of an apparatus, such as an antenna element, according to an example. In the example of FIG. 1, an antenna element 100 is depicted in plan and side views, and comprises a substrate 101. In an example, substrate 101 comprises glass. For example, substrate 101 can comprise a low-loss glass with, e.g., a low dielectric constant of around 4.0, which reduces signal delay and is suitable for broadband antenna designs and has minimal energy loss in high-frequency radiation use cases. Glass substrate 101 is also thermally and chemically stable. In an example, substrate 101 can comprise, Borofloat-33 glass, Photoetchable glass (PEG), and Fused Silica glass.

According to an example, glass substrate 101 can be one quarter guided wavelength in thickness.

Glass substrates can be combined with various metallization techniques to create effective SIW structures. These include conductive copper foil (CCF), conductive silver paste (CSP), and indium tin oxide (ITO) thin films. Each of these metallization schemes offers different performance characteristics and can be chosen based on the specific requirements of the antenna design.

In the example of FIG. 1, multiple through-glass vias (TGVs) 103 are provided in the glass substrate 101. Each via extends through the substrate 101 from a first surface 105 of the substrate 101 to a second surface 107 of the substrate 101. Each via 103 is formed from conductive material, e.g., by metallisation, either such that each via 103 is filled with conductive material such as metal or the sidewalls of each via 103 are coated with conductive material such as metal, or some combination of the two. It will be appreciated that other conductive materials can be used, such as one or more of, and not limited to: graphite, carbon nanotubes, plasma, superconductors, and organic conductors. The vias form a waveguide region 109 comprising a pair of sidewalls 111 and an end wall 113, which are configured to delimit a wave propagation area for the element 100.

A conductive radiator plane 115, which is configured to radiate, is formed on the first surface 105 of the substrate 101. A conductive ground plane 117 is formed on the second surface 107 of the substrate 101. The second surface 107 is a surface arranged to oppose the first surface 105 of the substrate 101. Accordingly, the conductive radiator plane 115 is provided on the other side of the substrate to the conductive ground plane 117. The conductive ground plane 117 and the conductive radiator plane 115 are galvanically coupled by way of the vias 103. In an example, the vias 103 are spaced apart from one another by at least 0.052 λ_{g}, where λ_{g} is the guided wavelength. In an example, the vias 103 form conductive grounding members between the conductive planes 115, 117.

In the example of FIG. 1, the conductive radiator plane 115 further comprises a first longitudinal slot 119 and a second longitudinal slot 121. The second longitudinal slot 121 is parallel to the first longitudinal slot 119. The second longitudinal slot 121 and the first longitudinal slot 119 can be etched in the conductive radiator plane 115 to form non-conductive closed slots.

In an example, the first longitudinal slot 119 has a first set of dimensions and the second longitudinal slot 121 has a second set of dimensions. The second set of dimensions are different to the first set of dimensions. That is, the first longitudinal slot 119 is a different shape to the second longitudinal slot 121. In the example of FIG. 1, each longitudinal slot 119, 121 is rectangular, but other shapes may be selected depending on the required characteristics of the antenna element.

A feed 123, such as in the form of a metallic probe or pin for example, is provided and configured to convey radio frequency signals between the conductive radiator plane 115 and radio frequency circuitry (not shown). The feed 123 may pass through the substrate 101 within the waveguide region 109 of the antenna element 100. In an example, the feed 123 may be terminated at the conductive radiator plane 115 using an anti-pad (not shown). Similarly, an anti-pad may be provided on the conductive ground plane 117 in the region of the feed 123. Accordingly, feed 123 can be electrically isolated from the conductive radiator plane 115 and the conductive ground plane 117. In the context of the present disclosure, an anti-pad comprises a void area around a via or plated through-hole (PTH) for signal isolation and to prevent short-circuiting.

According to an example, feed 123 can be used to provide a radio frequency signal for the antenna element 100. For example, feed 123 can be used to supply a radio frequency signal within the waveguide region 109, which is configured to excite the first slot 119 and the second slot 121 with a TE10 mode, i.e., a Transverse Electric mode with indices m=1 and n=0, where m represents the number of half-wavelength loops across the width of the waveguide region 109, and n represents the number of loops across the height of the waveguide region 109. For the TE10 mode there is one half-wavelength variation horizontally (m=1) and no variation vertically (n=0). It is the dominant mode in rectangular waveguides, having the lowest cutoff frequency, and the electric field is entirely transverse to the direction of propagation.

According to an example, adjustment of the width and length of each slot, the spacing between the slots, and the distance of the short-circuited via wall 113 from the slots, it is possible to combine the resonances from each slot. That is, there is a superposition of modes that results in a wide impedance bandwidth (e.g., |S₁₁|<−10 dB).

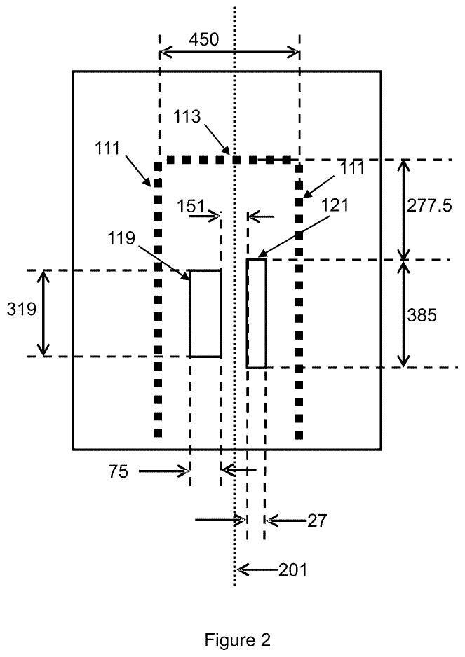

FIG. 2 is a schematic representation of an apparatus according to an example. In the example of FIG. 2, some exemplary slot dimensions are depicted (micrometers, um), along with an exemplary width between walls 111 and distance of the short-circuited via wall 113 from the slots. A centre line 201 of the antenna element is depicted.

With the dimensions presented in FIG. 2, a wide impedance bandwidth spanning from around 270 GHz to around 330 GHz is provided.

In an example, couplings and superposition of modes occur between the two differently sized slots 119, 121 and the backed cavity on the glass, thereby enabling a wide bandwidth antenna and beam pattern consistency over this wide bandwidth to be achieved.

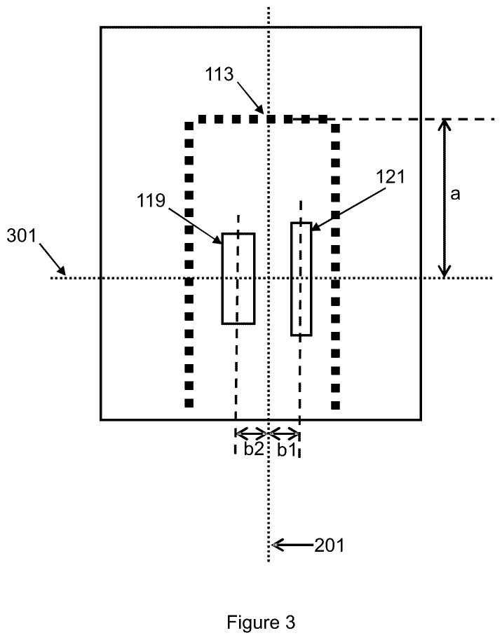

FIG. 3 is a schematic representation of an apparatus according to an example. In the example of FIG. 3 further dimensions relating to the relative position of slots for an antenna element are shown. The general dimensions described with reference to FIG. 3 are applicable to any antenna element described herein, including that described above with reference to FIG. 2 for example.

The distance, a, represents the distance from the shorted wall 113 of the waveguide region 109 to the centre of the slots 119, 121. Note that the spacing between the centre of the slots 119, 121 to the shorted wall 113 of the waveguide region 109 of the antenna is the same for both slots 119 and 121.

The distances, b1 and b2, represents the spacing between the centre of the slots 119, 121 to the centreline 201 of the antenna. In an example, b1=b2, however in other examples the values for b1 and b2 may differ as desired.

According to an example, the distance, a, may be three-quarters of the effective wavelength of an operational frequency of the antenna. An initial length for, e.g., slot 119 can be selected as one-half of the effective wavelength of an operational frequency of the antenna, in which case the length of slot 121 would be larger than one-half of the effective wavelength of an operational frequency of the antenna. The dimensions of the slots and the distances a, b1 and b2 can then be modified as desired in order to obtain a desired antenna response.

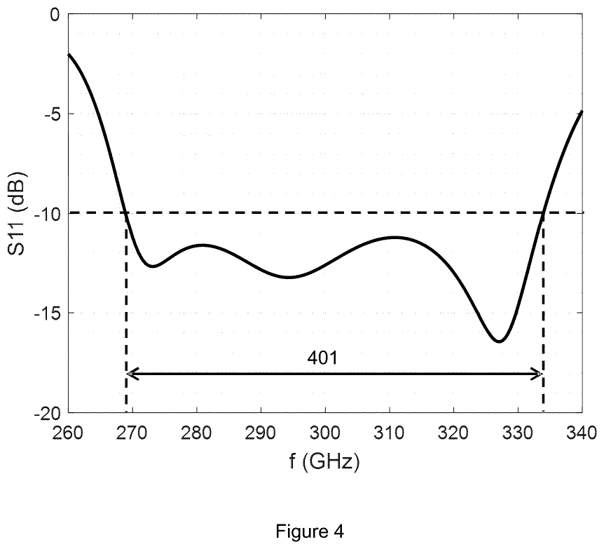

FIG. 4 is a graph of the scattering parameter (S11) for an apparatus, according to an example, with the dimensions described above with reference to FIGS. 2 and 3. For |S ₁₁|<−10 dB, the apparatus covers greater than 20% fractional bandwidth and greater than 60 GHz instantaneous bandwidth 401.

According to an example, an antenna element 100 can be attached to a RFIC structure to excite the antenna or for the antenna to excite the RFIC (i.e., in order to implement receive and/or transmit functionality). This is possible through an electrical interconnection like, e.g., a solder ball. The antenna element is then fed through probe 123. Feed parameters such as the size of the cavity around the probe feed 123 and anti-pads can be modified, whereby to minimize the insertion loss from the flip-chip to the antenna, which generates the required mode to excite the dual-longitudinal SIW slot antenna element. An antenna element as described herein can therefore be easily integrated with active circuits.

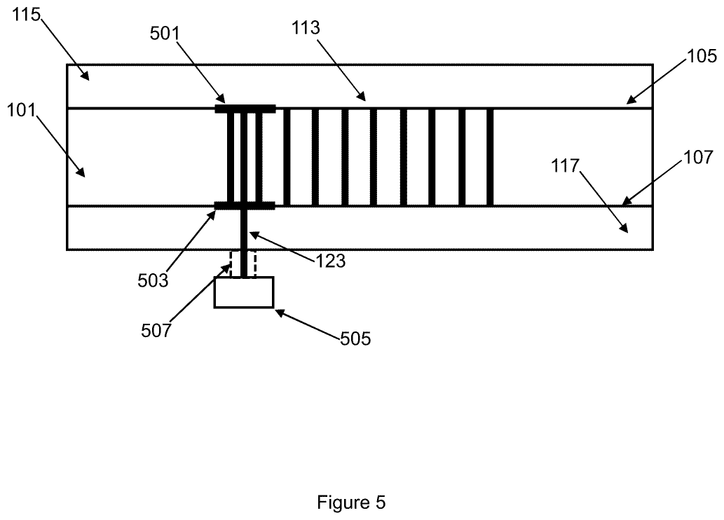

FIG. 5 is a schematic representation of a flip chip interconnection and probe fed cavity antenna element according to an example. In the example of FIG. 5, probe 123, comprising a feed for the antenna element is connected to an RFIC 505. Probe 123 passes through the conductive ground plane 117 and into the waveguide region 109. It is electrically isolated from both the conductive ground plane 117 and the conductive radiator plane 115 by way of anti-pads 503, 501. One or more copper pillars 507 may be provided to separate and/or support the antenna element.

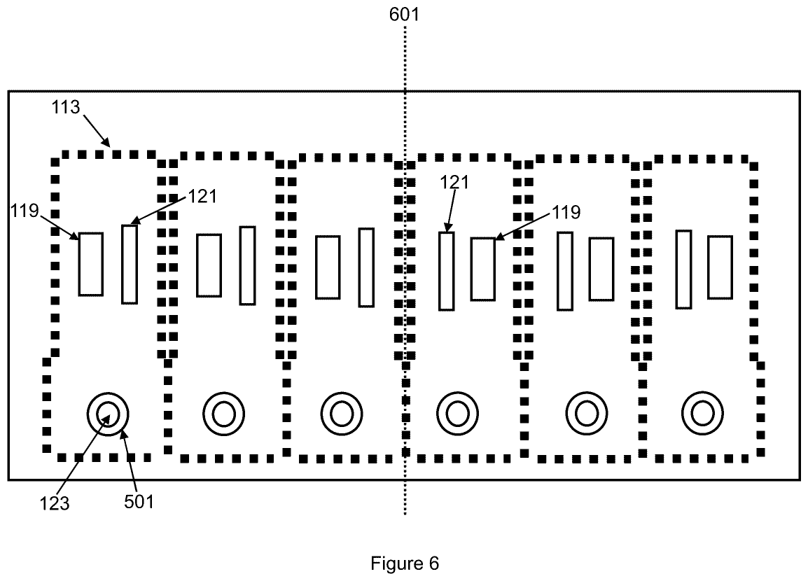

FIG. 6 is a schematic representation of a multiple-input and multiple-output, MIMO, radar system according to an example. In the example of FIG. 6, the slot arrangement of individual antenna elements is flipped from the center 601 of the array. As such, in the example shown, the slot arrangement for the antenna elements on either side of the center line 601 of the system of FIG. 6 are mirror images such center 601 represents a line of symmetry for the antenna elements of the system. In this manner, orthogonal transmitted signals achieve a uniform distribution of radiation energy over a wide angle, thereby enhancing the angular resolution of the radar system in a cost-effective manner. That is, antenna elements are mirrored around the axis of symmetry of the array. This provides an improved beam pattern flatness, which is a requirement for high resolution MIMO radar applications.

Each antenna element of the system shown in FIG. 6 may be connected to an RFIC structure as described above with reference to FIG. 5, for example. The system of FIG. 6 can be used as an transmit array antenna and/or a receive array antenna.

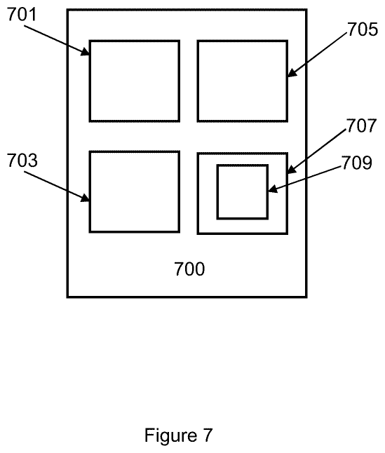

FIG. 7 is a schematic representation of an apparatus, according to an example. Apparatus 700 can comprise a platform comprising user equipment such as a smart device, e.g., a smart phone, for example, or can be part of, e.g., a network apparatus, radar system, or base station apparatus.

Apparatus 700 can comprise an antenna or antenna array, 701, such as that described above, which is configured to act as a transmit antenna or transmit antenna array, 701. Apparatus 700 can comprise an antenna or antenna array, 703, such as that described above, which is configured to act as a receive antenna or receive antenna array, 703. Apparatus 700 can comprise a processor 705, and a memory 707 configured to store instructions 709, executable by the processor 705. Instructions 709 can be instructions configured to operate an antenna or antenna array 701, 703, in a receive or transmit mode of operation as appropriate.

In an example, instructions 709 can be configured, when executed by processor 705, to cause the apparatus 700 to transmit orthogonal signals using an antenna 701 comprising an antenna element or antenna array as described above, and/or receive signals using an antenna 703 comprising an antenna element or antenna array as described above. Processor 705 can process received signals to enhance angular resolution for the apparatus, which can be part of a radar system such as a MIMO radar system for example. As described above, a transmit array 701 and/or a receive array 703 can be arranged in a mirrored configuration around an axis of symmetry to achieve uniform distribution of radiation energy over a wide angle.

According to the present disclosure, a dual-longitudinal SIW slot antenna using a glass substrate is therefore provided, which is suitable for integration into sub-THz MIMO array antenna in package (AiP) systems.

An antenna element according to an example comprises two parallel longitudinal slots on a SIW structure with a shorted end which offers a wide instantaneous bandwidth with a simple design, facilitating fabrication on a single-layer, low-loss Glass substrate.

Use of a glass substrate overcomes issues with PCB processes, which are not a suitable option for mm-Wave and sub-THz frequencies due to the limitations on via positioning accuracy and lithography precision problem at high frequencies. Glass technology can support very precise fabrication required for high frequency applications.

In an example, RFIC structure can be connected to an antenna element or array directly through flip-chip bonding.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

1. An apparatus comprising:
a glass substrate;
a conductive radiator plane formed on a first surface of the glass substrate;
a conductive ground plane formed on a second surface of the glass substrate, the second surface being a surface arranged to oppose the first surface of the glass substrate;
the conductive radiator plane further comprising a first longitudinal slot and a second longitudinal slot, the second longitudinal slot parallel to the first longitudinal slot, the first slot having a first set of dimensions and the second slot having a second set of dimensions, the second set of dimensions being different to the first set of dimensions;
a plurality of conductive grounding members arranged to be galvanically coupled between the conductive radiator plane and the ground plane for forming a waveguide; and
a feed configured to convey radio frequency signals between the conductive radiator plane and radio frequency circuitry,
wherein the first longitudinal slot is a different shape to the second longitudinal slot such that a width of the first longitudinal slot is different from a width of the second longitudinal slot, and
wherein a first distance between the centre of the first longitudinal slot and a centreline of the apparatus and a second distance between the centre of the second longitudinal slot and the centreline of the apparatus differ.

2. The apparatus of claim 1, wherein the plurality of conductive grounding members comprise through-glass vias, TGVs, extending through the glass substrate and connecting the conductive radiator plane to the conductive ground plane.

3. The apparatus of claim 1, wherein the first set of dimensions and the second set of dimensions are selected for the first and second longitudinal slots to provide at least a 20% fractional bandwidth for the apparatus.

4. The apparatus of claim 1, wherein the first set of dimensions and the second set of dimensions are selected for the first and second longitudinal slots to provide a wide instantaneous bandwidth spanning from 270 GHz to 330 GHz.

5. The apparatus of claim 1, wherein the feed extends into a probe feed cavity configured to excite the waveguide with a transverse electric, TE10, mode.

6. The apparatus of claim 5, wherein the radio frequency circuitry is a Radio-Frequency Integrated Circuit, RFIC, through flip-chip bonding, configured to electrically connect with the feed.

7. The apparatus of claim 1, wherein the plurality of conductive grounding members forming the waveguide form a waveguide region which comprises a pair of sidewalls and a short-circuited end wall at one end of the waveguide.

8. The apparatus of claim 1, wherein a first distance between the centre of the first longitudinal slot and a centreline of the apparatus and a second distance between the centre of the second longitudinal slot and the centreline of the apparatus are the same.

9. An antenna array comprising a plurality of the apparatus according to claim 1, wherein the first longitudinal and second longitudinal slots are mirrored around an axis of symmetry of the array.

10. The antenna array of claim 9, wherein the mirrored arrangement of first longitudinal and second longitudinal slots is configured to enhance beam pattern flatness for high-resolution multiple input multiple output, MIMO, radar applications.

11. A method comprising:
providing a glass substrate;
forming a conductive radiator layer on a first surface of the glass substrate, the conductive radiator layer comprising a pair of parallel longitudinal slots, wherein a first slot of the pair of parallel longitudinal slots comprises a first set of dimensions and the second slot of the pair of parallel longitudinal slots comprises a second set of dimensions, the second set of dimensions being different to the first set of dimensions;
forming a conductive ground plane layer on a second surface of the glass substrate, the second surface being a surface arranged to oppose the first surface of the glass substrate; and
creating a plurality of through-glass vias, TGVs, connecting the conductive radiator layer and the conductive ground plane layer,
wherein the first longitudinal slot is a different shape to the second longitudinal slot such that a width of the first longitudinal slot is different from a width of the second longitudinal slot, and
wherein a first distance between the centre of the first longitudinal slot and a centreline of the apparatus and a second distance between the centre of the second longitudinal slot and the centreline of the apparatus differ.

12. The method of claim 11, further comprising:
forming a feed configured to convey radio frequency signals between the conductive radiator layer and radio frequency circuitry.

13. A multiple input multiple output, MIMO, radar system comprising:
an antenna array configured to transmit radio frequency signals comprising a plurality of apparatus according to claim 1 or at least one antenna array; and
an antenna array configured to convey radio frequency signals comprising a plurality of apparatus or at least one antenna array.

14. The MIMO radar system of claim 13, wherein each of the plurality of apparatus in at least one of the transmit and receive array antennas are dual-longitudinal substrate integrated waveguide, SIW, slot antennas arranged in a mirrored configuration around an axis of symmetry to achieve uniform distribution of radiation energy over a wide angle.

15. A method of operating a MIMO radar system, comprising:
transmitting orthogonal signals using an array antenna comprising apparatus according to claim 1 or at least one antenna array;
receiving reflected signals using an array antenna comprising apparatus or at least one antenna array; and
processing the received signals to enhance angular resolution of the radar system.

16. The method of claim 15, wherein the apparatus in the transmit and receive array antennas are arranged in a mirrored configuration around an axis of symmetry to achieve uniform distribution of radiation energy over a wide angle.

17. User equipment, comprising:
an antenna array configured to transmit radio frequency signals comprising a plurality of apparatus according to claim 1 or at least one antenna array; and
an antenna array configured to convey radio frequency signals comprising a plurality of apparatus or at least one antenna array.

18. The user equipment of claim 17, wherein the user equipment comprises:
at least one processor; and
at least one memory, wherein the at least on memory is configured to store instructions, executable by the processor, to cause the user equipment to:
convey orthogonal signals using the antenna array; and/or
receive signals using the antenna array.

19. The user equipment of claim 18, further comprising instructions, executable by the processor, to cause the user equipment to:
process received signals to enhance angular resolution for the user equipment.

20. A node for a mobile communication network, the node comprising a MIMO radar system as claimed in claim 13.
